(19) United States
(12) Patent Application Publication
(10) Pub. No.: US 2026/0337730 A1
(43) Pub. Date: Oct. 29, 2026

(54) COMPOSITE SHIELDING YTTRIUM-BASED ALLOY MATERIAL, AND PREPARATION METHOD THEREFOR AND USE THEREOF

(71) Applicant: SHANGHAI NUCLEAR ENGINEERING RESEARCH & DESIGN INSTITUTE CO., LTD., Shanghai (CN)

(72) Inventors: Yong Wang, Shanghai (CN); Qiliang Mei, Shanghai (CN); Xueshan Xiao, Shanghai (CN); Hui Li, Shanghai (CN); Cong Li, Shanghai (CN); Mengqi Wang, Shanghai (CN); Jie Pan, Shanghai (CN); Qianxue Ding, Shanghai (CN); Jing Gao, Shanghai (CN); You Shi, Shanghai (CN); Tao Shi, Shanghai (CN); Dawei Sun, Shanghai (CN); Zheng Zheng, Shanghai (CN); Yan Zhou, Shanghai (CN)

(21) Appl. No.: 19/111,549

(22) PCT Filed: Jul. 20, 2023
(86) PCT No.: PCT/CN2023/108274

§ 371 Date: Mar. 13, 2025

(30) Foreign Application Priority Data
Sep. 16, 2022 (CN) 202211128393.5

(51) Int. Cl. C22C 28/00; C22C 1/02; C22F 1/16; G21F 1/08

(52) U.S. Cl. CPC C22C 28/00; C22C 1/02; C22F 1/16; G21F 1/085

(57) ABSTRACT

The present application relates to a composite shielding yttrium-based alloy material. The main components of the yttrium-based alloy material comprise the following components in percentage by mass: B: 0.05-10.0%, Cr≤6.0% or Al≤5.0%, and the remaining components of yttrium and other inevitable impurities. The grain size of the yttrium-based alloy material is 10-50 μm. Also provided are a preparation method for and a use of the composite shielding yttrium-based alloy material. The composite shielding yttrium-based alloy material of the present application can be used in high-temperature environments of 600 to 1,000 °C, has fine grains, relatively high strength and toughness and low density, and is a high-quality and efficient neutron moderation and absorption integrated alloy material.

### TECHNICAL FIELD

The present invention relates to the technical field of special alloy materials for nuclear energy, and specifically to a dysprosium-rich nickel-tungsten alloy material for nuclear shielding and a preparation method therefor.

### BACKGROUND

With the continuous development of aviation nuclear power and vehicle-mounted nuclear power propulsion, small nuclear reactor power supplies have been applied in a variety of demanding environments such as space operations and rapid orbital transfer. As an essential core component in nuclear reactors, the performance of neutron shielding materials affects the performance of nuclear reactor power supplies. At present, LiH (unstable, decomposing at around 600 °C), ZrH₂ (decomposing at around 800 °C), and TiHz (decomposing at around 800 °C) are used for neutron shielding in unmanned space reactors of the United States, the former Soviet Union and France, while the decomposition temperature of YH₂ is above 1000 °C, which is more stable. At present, the abnormally coarse grains and poor resistance to high-temperature oxidation of existing yttrium alloys lead to high-temperature hydrogen-induced embrittlement and easy occurrence of oxygen-nitrogen reactions on the surface; moreover, it can only shield fast neutrons, while its thermal neutron shielding ability is weak, which result in certain restrictions on engineering applications. As the shielding environment temperature for mobile reactors such as space reactors and vehicle-mounted reactors is getting higher and higher, there is an urgent need to develop new lightweight and efficient fast neutron and thermal neutron moderation and absorption integrated composite shielding materials with low density, strong shielding ability, high temperature resistance, and high-temperature oxidation resistance.

### SUMMARY

In order to solve the above problems, the present application provides a composite shielding yttrium-based alloy material that can be used in high-temperature environments of 600-1,000 °C. It has fine grains, relatively high strength and toughness and low density, and is a high-quality and efficient neutron moderation and absorption integrated alloy material.

The first aspect of the present application provides a composite shielding yttrium-based alloy material, wherein a composition of the yttrium-based alloy material includes the following main components in percentage by mass: B: 0.05-10.0%, Cr≤6.0% or Al≤5.0%, and a balance of yttrium and unavoidable impurities, wherein a grain size of the yttrium-based alloy material is in a range of 10-50 μm.

In an embodiment, 0.05-5.0% by mass of B is included.

In an embodiment, the grain size of the yttrium-based alloy material is in a range of 10-30 μm.

The above composite shielding yttrium-based alloy materials has a density in a range of 4.2-5.0 g/cm³.

The present application also provides a method for preparing the above composite shielding yttrium-based alloy material, including the following steps of:
(a) batching raw materials according to the following composition of main components in percentage by mass: B: 0.05-10.0%, Cr≤6.0% or Al≤5.0%, and the balance of yttrium and unavoidable impurities, performing a special vacuum smelting process on all the raw materials weighed after the batching to obtain an alloy melt, and casting the alloy melt into an alloy ingot; and
(b) performing hot forging or hot pressing, hot rolling, cold rolling, annealing and hydrogenation processes sequentially on the alloy ingot prepared in step (a) to finally produce a composite shielding yttrium-based alloy material plate.

In an embodiment, the special vacuum smelting process includes the following steps of: putting the prepared raw materials into a special vacuum furnace, evacuating the furnace to 3×10⁻³ Pa, and introducing argon gas therein as a protective gas; and heating up the special vacuum furnace to 1,700 °C at a heating rate of 100 °C/min, maintaining the temperature while performing melting for 10 minutes to obtain the alloy melt, and casting the alloy melt into shape.

In an embodiment, in step (b), when the hot pressing and hot rolling processes are performed on the alloy ingot, a processing temperature for the hot pressing process is controlled at 800 °C, and a temperature for the hot rolling process is controlled at 850 °C; and the hot rolling process is repeated for 3 times, and then the cold rolling process is performed for 3 times.

In an embodiment, the annealing and hydrogenation processes include an annealing heat treatment and a hydrogenation process heat treatment in an argon protective atmosphere, followed by cooling to room temperature, so as to finally produce the composite shielding yttrium-based alloy material plate.

The present application also provides use of the above composite shielding yttrium-based alloy material in neutron moderation and absorption integrated composite shielding bodies in space reactors and vehicle-mounted reactors.

The present application achieves the following advantageous effects:
(1) Compared with LiH, ZrH₂ and TiH₂ for current neutron shielding, the yttrium-based alloy material for neutron moderation and absorption integrated composite shielding of the present invention has a higher service temperature, and can be used in an environment of high temperatures of 600-1,000 °C, which can avoid the problem of hydrogen loss at a high temperature, and it is a high-efficiency and high temperature resistant neutron moderation and absorption integrated composite shielding material.
(2) After the lightweight, high-efficiency, high temperature resistant neutron moderation and absorption integrated composite shielding yttrium-based alloy material of the present invention undergoes hot rolling or hot pressing, annealing treatment, hydrogenation treatment and other processes within its composition range, since the alloy material has fine grains, relatively high strength and toughness, while boron has a large thermal neutron absorption cross section (759 b) which can absorb thermal neutrons, it is the best candidate material for future replacement of LiH, ZrH2 and TiHz series for current neutron shielding, and is a high-efficiency and high temperature resistant neutron moderation and absorption integrated composite shielding material.
(3) The lightweight, high-efficiency and high temperature resistant neutron moderation and absorption integrated composite shielding yttrium-based alloy material of the present invention has low density (4.2-5.0 g/cm³), high strength, high temperature resistance, good plasticity and toughness, oxidation resistance, radiation resistance, and simple production process. The lightweight, high-efficiency neutron moderation and absorption integrated composite shielding yttrium-based alloy material of the present invention can be used as neutron moderation and absorption integrated composite shielding bodies in mobile reactors such as space reactors and vehicle-mounted reactors.

### BRIEF DESCRIPTION OF THE DRAWINGS

In order to illustrate the technical solutions of the embodiments of the present application more clearly, the accompanying drawing to be used in the embodiments of the present application will be briefly introduced below. Apparently, the accompanying drawings described below are only the specific embodiments of the present application, and those skilled in the art can obtain other embodiments according to the following FIGURE without making creative efforts.

FIG. 1 is a metallographic structure diagram of the composite shielding yttrium-based alloy material in Embodiment 1 of the present application.

The accompanying drawing, which is incorporated in and constitutes a part of the specification, illustrates embodiments consistent with the present application and together with the description serves to explain the principles of the present application.

### DETAILED DESCRIPTION

In order to better understand the technical solutions of the present application, the embodiments of the present application will be described in detail below in conjunction with the accompanying drawings.

### Embodiment 1

In Embodiment 1, a method for preparing a high temperature resistant neutron moderation and absorption integrated composite shielding yttrium-based alloy material is adopted, which includes the following steps:
a. A special vacuum smelting process is adopted; and during raw material batching, the raw material components used are batched according to the following composition in percentage (%) by mass:
B 0.05
Y balance

The raw materials weighed after the batching are mixed; a vacuum melting process is performed, the raw materials are put into a special vacuum furnace, which is evacuated to 3×10⁻³ Pa; then high-purity argon is introduced as the protective gas; and the furnace is heated up to
1,700 °C at a heating rate of 100 °C/min and this temperature is maintained while performing melting for 10 minutes to obtain an alloy melt.

b. The alloy melt prepared in step a is cast into shape, and the alloy ingot obtained by casting is sequentially subjected to hot forging or hot pressing, hot rolling, annealing and hydrogenation processes. The processing temperature for the hot pressing process is controlled to be 800 °C, and the temperature for the hot rolling process is 850 °C; and the hot rolling process is repeated for 3 times, and then a cold rolling process is performed for 3 times, so as to finally produce a high temperature resistant composite neutron shielding yttrium-based alloy plate.

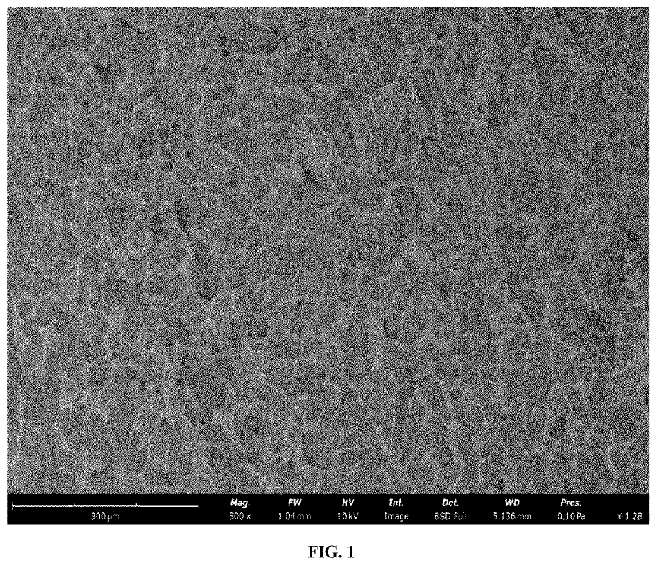

After the grain size test experiment, the test results show that the alloy material prepared in this embodiment has a grain size of 10-50 μm, as shown in FIG. 1, and its material density is in a range of 4.45-4.47 g/cm³, thus it can be used as a neutron moderation and absorption integrated composite shielding material, is the best candidate material for future replacement of LiH, ZrH₂ and TiH₂ series for current neutron shielding, and is a high-efficiency and high temperature resistant neutron moderation and absorption integrated composite shielding yttrium-based alloy material.

### Embodiment 2

The preparation method of Embodiment 2 is basically the same as that of Embodiment 1, and the special features of Embodiment 2 are as follows:

The raw material components used are batched according to the following composition in percentage (%) by mass:
B 0.5
Y balance
After the grain size test experiment, the test results show that the alloy material prepared in this embodiment has a grain size of 10-50 μm, and its material density is in a range of 4.4-4.65 g/cm³, thus it can be used as a neutron moderation and absorption integrated composite shielding material, is the best candidate material for future replacement of LiH, ZrH₂ and TiHle series for current neutron shielding, and is a high-efficiency and high temperature resistant neutron moderation and absorption integrated composite shielding yttrium-based alloy material.

### Embodiment 3

The preparation method of Embodiment 3 is basically the same as that of Embodiment 1, and the special features of Embodiment 3 are as follows:

During raw material batching, the raw material components used are batched according to the following composition in percentage (%) by mass:
B 2.0
Y balance

After the grain size test experiment, the test results show that the alloy material prepared in this embodiment has a grain size of 10-50 μm, and its material density is in a range of 4.4-4.6 g/cm³, thus it can be used as a neutron moderation and absorption integrated composite shielding material, is the best candidate material for future replacement of LiH, ZrH₂ and TiHz series for current neutron shielding, and is a high-efficiency and high temperature resistant neutron moderation and absorption integrated composite shielding yttrium-based alloy material.

### Embodiment 4

The preparation method of Embodiment 4 is basically the same as that of Embodiment 1, and the special features of Embodiment 4 are as follows:

During raw material batching, the raw material components used are batched according to the following composition in percentage (%) by mass:
B 5.0
Y balance

After the grain size test experiment, the test results show that the alloy material prepared in this embodiment has a grain size of 10-30 μm, smaller grains giving the material higher strength and toughness; and its material density is in a range of 4.3-4.55 g/cm³, thus it can be used as a neutron moderation and absorption integrated composite shielding material, is the best candidate material for future replacement of LiH, ZrH₂ and TiHz series for current neutron shielding, and is a high-efficiency and high-temperature resistant neutron moderation and absorption integrated composite shielding yttrium-based alloy material.

### Embodiment 5

The preparation method of Embodiment 5 is basically the same as that of Embodiment 1, and the special features of Embodiment 5 are as follows:

During raw material batching, the raw material components used are batched according to the following composition in percentage (%) by mass:
B 8.0
Y balance

After the grain size test experiment, the test results show that the alloy material prepared in this embodiment has a grain size of 10-50 μm, and its material density is in a range of 4.3-4.45 g/cm³, thus it can be used as a neutron moderation and absorption integrated composite shielding material, is the best candidate material for future replacement of LiH, ZrH₂ and TiH₂ series for current neutron shielding, and is a high-efficiency and high temperature resistant neutron moderation and absorption integrated composite shielding yttrium-based alloy material.

### Embodiment 6

The preparation method of Embodiment 6 is basically the same as that of Embodiment 1, and the special features of Embodiment 6 are as follows:

During raw material batching, the raw material components used are batched according to the following composition in percentage (%) by mass:
B 10.0
Y balance

After the grain size test experiment, the test results show that the alloy material prepared in this embodiment has a grain size of 10-50 μm, and its material density is in a range of 4.2-4.35 g/cm³, thus it can be used as a neutron moderation and absorption integrated composite shielding material, is the best candidate material for future replacement of LiH, ZrH₂ and TiH₂ series for current neutron shielding, and is a high-efficiency and high temperature resistant neutron moderation and absorption integrated composite shielding yttrium-based alloy material.

### Embodiment 7

The preparation method of Embodiment 7 is basically the same as that of Embodiment 1, and the special features of Embodiment 7 are as follows:

During raw material batching, the raw material components used are batched according to the following composition in percentage (%) by mass:
B 1.0
Cr 6.0
Y balance

After the grain size test experiment, the test results show that the alloy material prepared in this embodiment has a grain size of 10-50 μm, and its material density is in a range of 4.85-5.0 g/cm³, thus it can be used as a neutron moderation and absorption integrated composite shielding material, is the best candidate material for future replacement of LiH, ZrH₂ and TiHz series for current neutron shielding, and is a high-efficiency and high-temperature resistant neutron moderation and absorption integrated composite shielding yttrium-based alloy material.

### Embodiment 8

The preparation method of Embodiment 8 is basically the same as that of Embodiment 1, and the special features of Embodiment 8 are as follows:

During raw material batching, the raw material components used are batched according to the following composition in percentage (%) by mass:
B 0.5
A 1 5.0
Y balance

After the grain size test experiment, the test results show that the alloy material prepared in this embodiment has a grain size of 10-50 μm, and its material density is in a range of 4.5-4.75 g/cm³, thus it can be used as a neutron moderation and absorption integrated composite shielding material, is the best candidate material for future replacement of LiH, ZrH₂ and TiH2 series for current neutron shielding, and is a high-efficiency and high temperature resistant neutron moderation and absorption integrated composite shielding yttrium-based alloy material.

In the composite shielding yttrium-based alloy material prepared in the present application, Y has a lower density, and the yttrium hydride obtained after the hydrogenation treatment has a higher decomposition temperature and excellent ability to shield fast neutrons at high temperatures. The average thermal neutron absorption cross section of B elements reaches 750 b, which has excellent thermal neutron absorption ability, and moreover, the B elements and yttrium form YB₂ having a high melting point to play a role in refining the grains. Cr elements and Al elements can improve the high-temperature oxidation resistance of yttrium-based alloys. Therefore, the composite shielding yttrium-based alloy material of the present application not only has good oxidation resistance, high strength and toughness, but can also efficiently achieve the integration of moderation and absorption of fast neutron and thermal neutron; and due to its low density, it can also meet application scenarios such as space reactors and vehicle-mounted micro-reactors that have strict weight and volume requirements.

The above are only preferred embodiments of the present application, and are not intended to limit the present application. For those skilled in the art, the present application may have various modifications and changes. Any modifications, equivalent replacements, improvements, etc. made within the ideas and principles of the present application shall be included within the protection scope of the present application.

1. A composite shielding yttrium-based alloy material, wherein a composition of the yttrium-based alloy material comprises the following main components in percentage by mass:
B: 0.05-10.0%, Cr≤6.0% or Al≤5.0%, and a balance of yttrium and unavoidable impurities,
wherein the yttrium-based alloy material has a grain size in a range of 10-50 μm.

2. The composite shielding yttrium-based alloy material according to claim 1, wherein 0.05-5.0% by mass of B is comprised.

3. The composite shielding yttrium-based alloy material according to claim 2, wherein the yttrium-based alloy material has a grain size in a range of 10-30 μm.

4. The composite shielding yttrium-based alloy material according to claim 1, wherein the composite shielding yttrium-based alloy material has a density in a range of 4.2-5.0 g/cm³.

5. A method for preparing the composite shielding yttrium-based alloy material according to claim lany comprising the following steps of:
(a) batching raw materials according to the following composition of main components in percentage by mass: B: 0.05-10.0%, Cr≤6.0% or Al≤5.0%, and the balance of yttrium and unavoidable impurities, performing a special vacuum smelting process on all the raw materials weighed after the batching to obtain an alloy melt, and casting the alloy melt into an alloy ingot; and
(b) performing hot forging or hot pressing, hot rolling, cold rolling, annealing and hydrogenation processes sequentially on the alloy ingot prepared in step (a) to finally produce a composite shielding yttrium-based alloy material plate.

6. The method for preparing the composite shielding yttrium-based alloy material according to claim 5, wherein the special vacuum smelting process comprises the following steps of: putting the prepared raw materials into a special vacuum furnace, evacuating the furnace to 3×10⁻³ Pa, and introducing argon gas therein as a protective gas; and
heating up the special vacuum furnace to 1,700 °C at a heating rate of 100 °C/min, maintaining the temperature while performing melting for 10 minutes to obtain the alloy melt, and casting the alloy melt into shape.

7. The method for preparing the composite shielding yttrium-based alloy material according to claim 6, wherein in the step (b), when the hot pressing and hot rolling processes are preformed on the alloy ingot, a processing temperature for the hot pressing process is controlled at 800 °C, and a temperature for the hot rolling process is controlled at 850 °C; and the hot rolling process is repeated for 3 times, and then the cold rolling process is performed for 3 times.

8. The method for preparing the composite shielding yttrium-based alloy material according to claim 6, wherein the annealing and hydrogenation processes comprise an annealing heat treatment and a hydrogenation process heat treatment in an argon protective atmosphere, followed by cooling to room temperature, so as to finally produce the composite shielding yttrium-based alloy material plate.

9. Use of the composite shielding yttrium-based alloy material according to claim lany in neutron moderation and absorption integrated composite shielding bodies in space reactors and vehicle-mounted reactors.
